(19) United States
(12) Patent Application Publication
(10) Pub. No.: US 2012/0327033 A1
(43) Pub. Date: Dec. 27, 2012

(54) INPUT DEVICE

(75) Inventors: Yusuke SHIMIZU, Ibaraki-shi (JP); Toru MIZUTANI, Ibaraki-shi (JP); Ryusuke NAITO, Ibaraki-shi (JP); Toshiki NAITO, Ibaraki-shi (JP); Shinichi INOUE, Ibaraki-shi (JP)

(73) Assignee: NITTO DENKO CORPORATION, Osaka (JP)

(21) Appl. No.: 13/468,364

(22) Filed: May 10, 2012

Related U.S. Application Data
(60) Provisional application No. 61/504,519, filed on Jul. 5, 2011.

(30) Foreign Application Priority Data
Jun. 23, 2011 (JP) 2011-139481

(51) Int. Cl. G06F 3/042

(52) U.S. Cl. 345/175

(57) ABSTRACT

An input device which allows a user to erase display information such as a character inputted thereto is provided. The input device includes a rectangular frame-shaped optical waveguide having a rectangular hollow input-use interior, and a control means provided on the outside of one of the sides of the optical waveguide. The optical waveguide and the control means are provided on a surface of a rectangular frame-shaped retainer plate having the hollow input-use interior, and are covered with a rectangular frame-shaped protective plate. The control means includes: a light-emitting element connected to ends of light-emitting cores of the optical waveguide; a light-receiving element connected to ends of light-receiving cores of the optical waveguide; and a CPU incorporating a program for recognizing the size of the tip of a pen and the size of the tip of an eraser in a region within the hollow input-use interior.

### RELATED APPLICATIONS

This application claims the benefit of U.S. Provisional Application No. 61/504,519 filed on Jul. 5, 2011, which is hereby incorporated by reference.

### FIELD OF THE INVENTION

The present invention relates to an input device including an optical position detection means.

### BACKGROUND OF THE INVENTION

Conventionally, an optical position detection device (as disclosed in, for example, Japanese Patent No. 3682109) including a plurality of light-emitting elements and a plurality of light-receiving elements is proposed as an input device. This optical position detection device is in the form of a rectangular frame comprised of a pair of L-shaped sections. The light-emitting elements are disposed in juxtaposition in one of the L-shaped sections of the rectangular frame, and the light-receiving elements opposed to the light-emitting elements are disposed in juxtaposition in the other L-shaped section thereof. The rectangular frame-shaped optical position detection device is placed along the periphery of a rectangular display. Information such as a character is inputted to the optical position detection device and is caused to appear on the rectangular display by moving a pen, a finger or the like within the rectangular frame of the optical position detection device. Specifically, when a pen, a finger or the like is moved within the rectangular frame, some light beams emitted from the light-emitting elements are intercepted by the tip of the pen, the finger or the like. The light-receiving elements opposed to the light-emitting elements sense the interception of light beams to thereby detect the path of the tip of the pen, the finger or the like (input information such as a character). The path is outputted as a signal to the rectangular display.

However, the rectangular frame-shaped optical position detection device does not include a system for partially erasing the information such as a character appearing on the display. It is hence impossible to erase errors in writing, if any. A user has no choice but to input a double line, a cross or the like over the errors appearing on the display, thereby causing the double line, the cross or the like to appear on the display. The double line, the cross or the like appearing on the display is unsightly.

### SUMMARY OF THE INVENTION

An input device is provided which allows a user to erase display information such as a character inputted thereto.

The input device which comprises: a frame-shaped plate having a space surrounded by the frame and serving as a hollow input-use interior, the frame-shaped plate including a pair of sections opposed to each other; a light-emitting means provided on one of the opposed sections of the frame-shaped plate; a light-receiving means provided on the other of the opposed sections of the frame-shaped plate and for receiving light emitted from the light-emitting means; the input device being configured such that the path of movement of a tip input part of an input element within the hollow input-use interior serves as input information; a size recognizing means for recognizing a tip erasing part of an erasing element, based on a difference in size, when the tip erasing part of the erasing element different in size from the tip input part of the input element is moved within the hollow input-use interior; and an erasure information recognizing means for recognizing inputted information over which the tip erasing part is moved as erasure information.

The input device includes the size recognizing means, and the erasure information recognizing means. Thus, when a user moves the erasing element (such as an eraser) having the tip erasing part different in size from the tip input part (such as a pen tip and a finger tip) of the input element (such as a pen and a finger) over the inputted information within the hollow input-use interior as if to erase the inputted information with an eraser, the size recognizing means recognizes the tip erasing part, based on the difference in size between the tip input part and the tip erasing part. Then, the erasure information recognizing means recognizes the inputted information over which the tip erasing part is moved as the erasure information. Based on this recognition, the erasure information, for example, may be erased from a display, erased from data, and moved to another page (layer) in terms of data so as to be able to be restored.

Preferably, the tip erasing part of the erasing element is greater in size than the tip input part of the input element. Since the tip of a generally commercially available eraser is greater in size than the tip of a generally commercially available pen and the tip of a human finger, the eraser may be used as the erasing element, and may be used for the input device in a similar manner to erasing a character and the like with the eraser.

Preferably, the light-emitting means includes a light-emitting element, and a plurality of light-emitting cores of an optical waveguide, the light-emitting cores being connected to the light-emitting element; the light-receiving means includes a light-receiving element, and a plurality of light-receiving cores of the optical waveguide, the light-receiving cores being connected to the light-receiving element; and tips of the light-emitting cores and tips of the light-receiving cores are opposed to each other while being positioned on inner edges of the frame-shaped plate. In such a case, the optical waveguide is formed on the frame-shaped plate, and is made thin. Thus, when a user performs an input operation with the input element and performs an erasure operation with the erasing element, the input device does not serve as an impediment to the use of the input element and the erasing element. This facilitates the use of the input element and the erasing element.

Preferably, the light-emitting means includes a plurality of light-emitting elements; the light-receiving means includes a plurality of light-receiving elements; and the light-emitting elements and the light-receiving elements are opposed to each other while being positioned on inner edges of the frame-shaped plate. In such a case, the light-emitting elements and the light-receiving elements have a certain amount of thickness, and the input device accordingly has a certain amount of thickness as a whole. This allows the input device to have a certain amount of rigidity and strength.

### BRIEF DESCRIPTION OF THE DRAWINGS

FIG. 1 is a perspective view schematically showing an input device according to a first preferred embodiment.

FIG. 2A is a plan view schematically showing an optical waveguide for the input device.

FIG. 2B is a sectional view, on an enlarged scale, taken along the line X1-X1 of FIG. 2A.

FIG. 2C is a sectional view, on an enlarged scale, taken along the line X2-X2 of FIG. 2A.

FIG. 3 is a flow diagram illustrating a program for a CPU of the input device.

FIG. 4 is a flow diagram illustrating a program for the CPU of the input device according to a second preferred embodiment.

FIG. 5 is a flow diagram illustrating a program for the CPU of the input device according to a third preferred embodiment.

FIGS. 6A to 6C, 7A to 7C, 8A, 8B, 9A and 10 are views schematically illustrating an exemplary method of producing the input device.

FIG. 9B is a sectional view taken along the line X4-X4 of FIG. 9A.

FIG. 11 is a plan view schematically showing the input device according to a fourth preferred embodiment.

### DETAILED DESCRIPTION OF THE INVENTION

Preferred embodiments according to the present invention will now be described in detail with reference to the drawings.

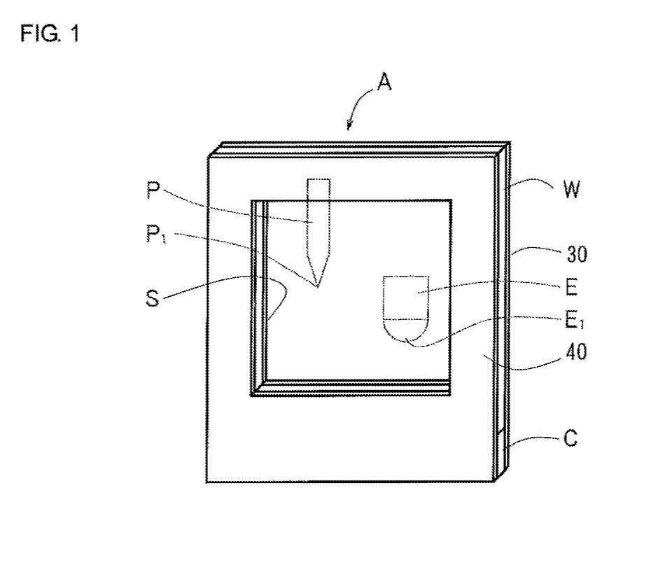

FIG. 1 is a perspective view showing an input device according to a first preferred embodiment. The input device A according to the first preferred embodiment includes: a rectangular frame-shaped optical waveguide W having a rectangular hollow input-use interior (window) S; and a control means C provided on the outside of one of the four sides of the optical waveguide W. The optical waveguide W and the control means C are provided on a surface of a rectangular frame-shaped retainer plate (frame-shaped plate) 30 having the hollow input-use interior S, and are covered with a rectangular frame-shaped protective plate 40 having the hollow input-use interior S. The control means C includes a CPU (central processing unit) (not shown) for controlling the input device A. The CPU incorporates a program (a size recognizing means) for recognizing the size (or width) of a pen tip (a tip input part) P₁ of a pen (an input element) P and the size (or width) of a tip (a tip erasing part) E₁ of an eraser (an erasing element) E in a region within the hollow input-use interior S of the optical waveguide W, and a program (an erasure information recognizing means) for recognizing inputted information lying in a range within which the eraser tip E₁ is moved as erasure information.

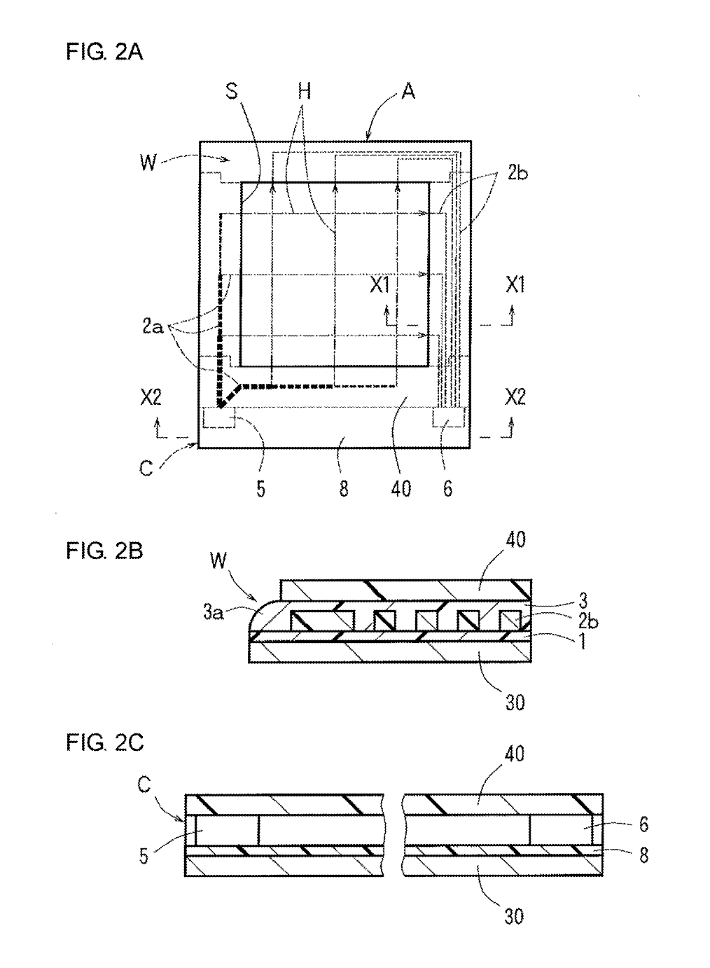

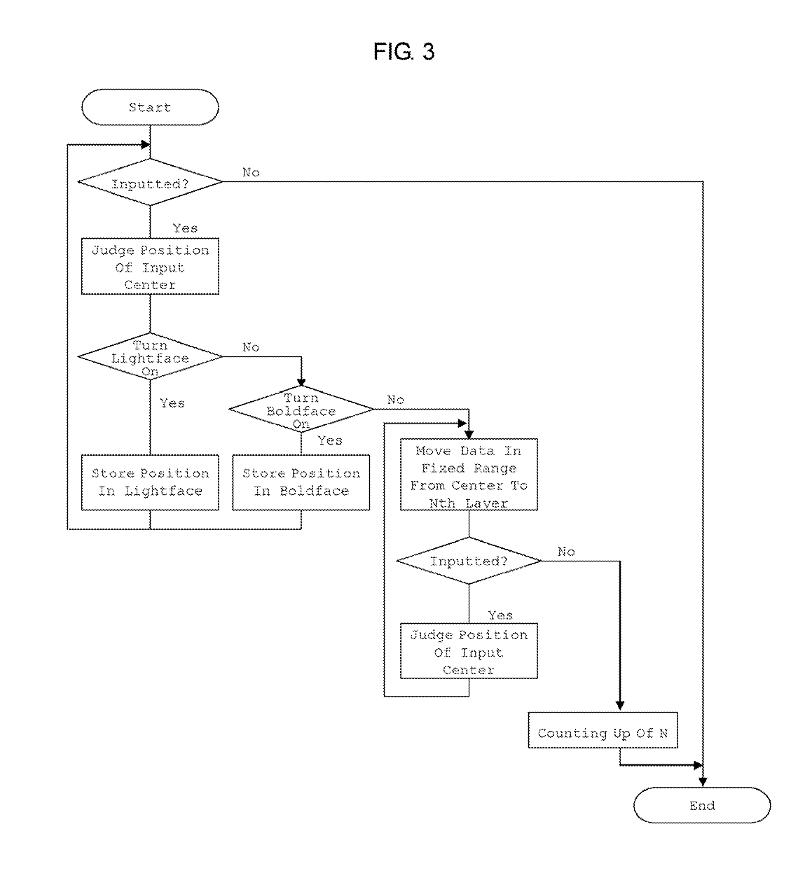

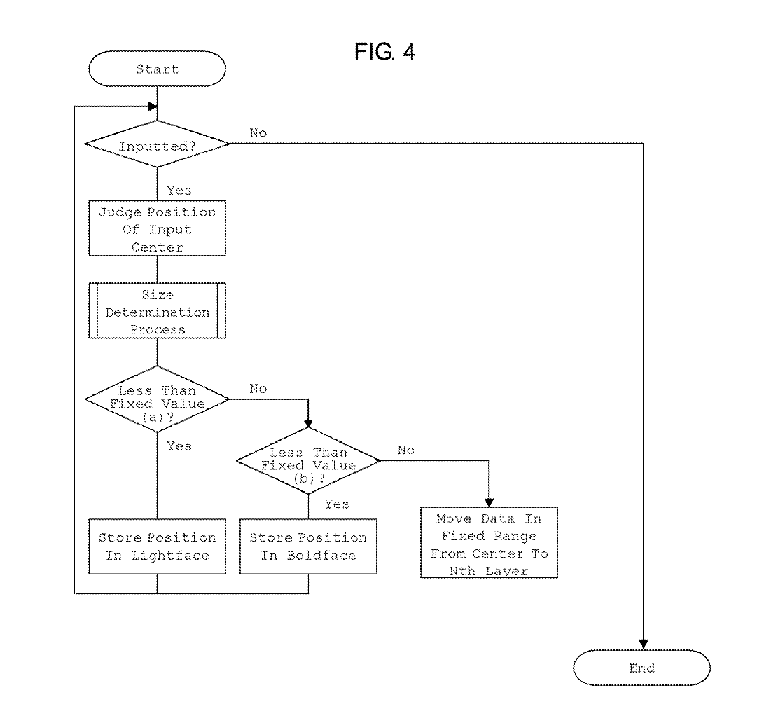

This will be described in further detail. As shown in FIG. 2A which is a plan view and in FIG. 2B which is a sectional view, on an enlarged scale, taken along the line X1-X1 of FIG. 2A, the rectangular frame-shaped optical waveguide W is configured such that four strip-shaped optical waveguide sections corresponding to the respective sides of the rectangular frame shape of the optical waveguide W are produced individually and then connected together into the shape of the rectangular frame. In the first preferred embodiment, opposite end edges of each of the strip-shaped optical waveguide sections have step portions. Adjacent ones of the optical waveguide sections, which are positioned relative to each other using the step portions, are connected to each other. Each of the strip-shaped optical waveguide sections includes an under cladding layer 1, cores 2a and 2b formed in a predetermined pattern on a surface of the under cladding layer 1, and an over cladding layer 3 formed on the surface of the under cladding layer 1 so as to cover the cores 2a and 2b. The under cladding layer 1 is affixed to the surface of the rectangular frame-shaped retainer plate 30.

In the rectangular frame-shaped optical waveguide W, the under cladding layer 1 is in the shape of a rectangular frame comprised of a pair of L-shaped sections. The light-emitting cores 2a are disposed in a divided manner on the surface of one of the L-shaped sections, and the light-receiving cores 2b are disposed in juxtaposition on the surface of the other L-shaped section. The cores 2a and 2b have respective tips positioned on the inner edges of the pair of L-shaped sections (the inner peripheral edges of the rectangular frame). The tips of the light-emitting cores 2a are in opposed relation to the tips of the light-receiving cores 2b. The over cladding layer 3 in the shape of a rectangular frame is formed on the surface of the under cladding layer 1 so as to cover the light-emitting cores 2a and the light-receiving cores 2b. In the first preferred embodiment, each of the tips of the cores 2a and 2b positioned on the inner peripheral edges of the rectangular frame is in the form of a convex lens portion having a substantially semicircular curved surface as seen in plan view, and an edge portion of the over cladding layer 3 covering the lens portions is in the form of a convex lens portion 3a having a substantially quadrantal curved surface as seen in sectional side view. In FIG. 2A, the cores 2a and 2b are indicated by broken lines, and the thickness of the broken lines indicates the width of the cores 2a and 2b. Also, in FIGS. 2A and 2B, the number of cores 2a and 2b are shown as abbreviated.

As shown in FIG. 2A in plan view and in FIG. 2C which is a sectional view, on an enlarged scale, taken along the line X2-X2 of FIG. 2A, on the other hand, the control means C includes: a light-emitting element 5 connected to ends of the light-emitting cores 2a of the optical waveguide W; a light-receiving element 6 connected to ends of the light-receiving cores 2b of the optical waveguide W; and the CPU (not shown) for controlling the input device A as mentioned earlier. The CPU incorporates the program for recognizing the size of the pen tip P₁ of the pen P (with reference to FIG. 1) and the size of the tip E₁ of the eraser E (with reference to FIG. 1) in the region within the hollow input-use interior S of the optical waveguide W, and the program for recognizing the inputted information lying in the range within which the eraser tip E₁ is moved as the erasure information, as mentioned earlier.

The control means C according to the first preferred embodiment can further include a lightface switch (not shown) which is turned on for the input in lightface, and a boldface switch (not shown) which is turned on for the input in boldface. The control means C can further include an output module (not shown) for outputting information inputted in the region within the hollow input-use interior S of the optical waveguide W (information about the movement path of the pen tip P₁ and the eraser tip E1), a storage means (not shown) for storing the information therein, a battery (not shown) serving as a power source, and the like. The light-emitting element 5, the light-receiving element 6, the CPU, the lightface switch, the boldface switch, the output module, the storage means, the battery and the like are mounted on a circuit board 8, and are electrically properly connected. For ease of manipulation, the lightface switch and the boldface switch are preferably provided so as to protrude from the front surface, a peripheral surface or the like of the input device A.

In such an input device A, light beams H from the light-emitting element 5 pass through the light-emitting cores 2a and through the lens portions at the tips of the respective light-emitting cores 2a, and then exit the surface of the lens portion 3a of the over cladding layer 3 covering the lens portions at the tips of the respective light-emitting cores 2a. The exit of the light beams H causes the light beams H to travel in a lattice form in the region within the hollow input-use interior S of the rectangular frame-shaped optical waveguide W. The light beams H traveling in a lattice form are restrained from diverging by refraction through the lens portions at the tips of the light-emitting cores 2a and through the lens portion 3a of the over cladding layer 3 covering the lens portions at the tips of the light-emitting cores 2a. The light beams H are transmitted through the lens portion 3a on a light-receiving side of the over cladding layer 3 and through the lens portions at the tips of the respective light-receiving cores 2b. Then, the light beams H pass through the light-receiving cores 2b to reach the light-receiving element 6. The light beams H entering the light-receiving cores 2b are narrowed down and converged by refraction through the lens portion 3a of the over cladding layer 3 and through the lens portions at the tips of the light-receiving cores 2b.

An example of the input of information by means of the input device A is as follows. A user places the input device A on a paper sheet, and writes a character, a drawing, a mark or the like with the pen P on part of the paper sheet revealed in the region within the hollow input-use interior S where the light beams H travel in the lattice form as mentioned above. During the writing operation, some of the light beams H traveling in the lattice form are intercepted by the pen tip P₁ of the pen P. The light-receiving element 6 senses the interception of light beams to thereby detect the path of the pen tip P₁. The path of the pen tip P₁ serves as input information such as a character, a drawing, a mark or the like.

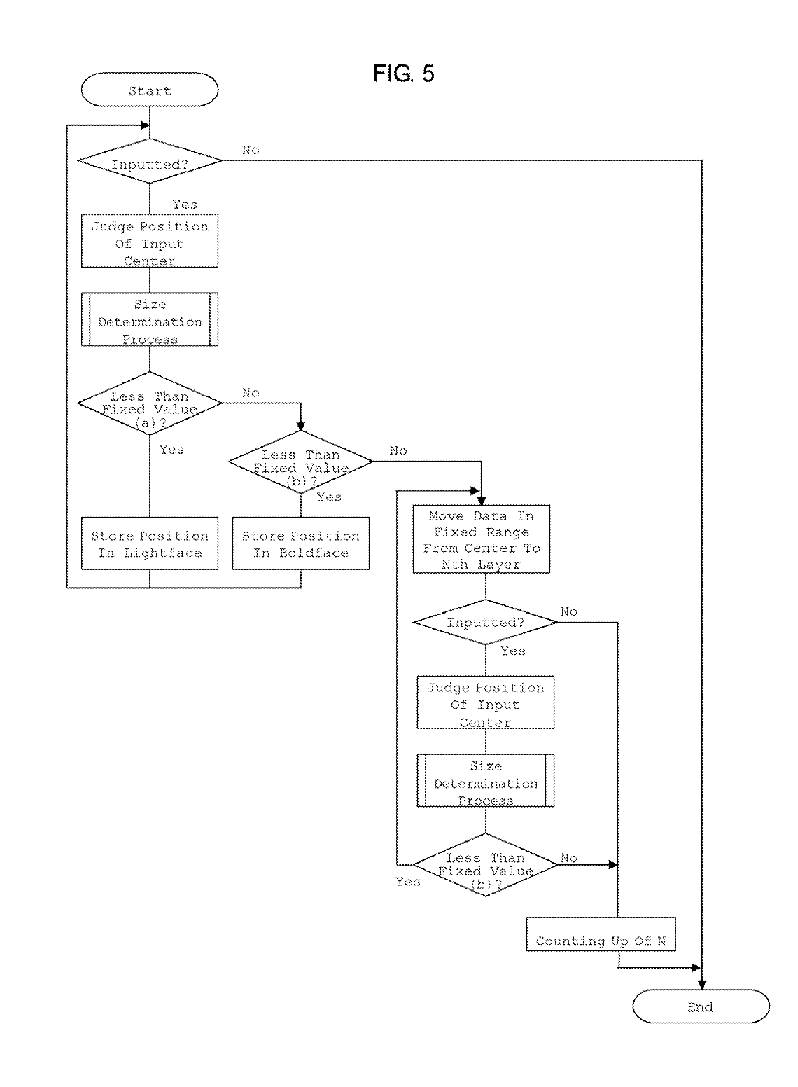

In the first preferred embodiment, the programs incorporated in the CPU of the control means C effect control as shown in the flow diagram of FIG. 3. Specifically, when the user places the pen tip P₁ in the region within the hollow input-use interior S, the position of the center of the pen tip P₁ is judged. When the user turns on the lightface switch and inputs a character or the like, the position of the inputted character or the like in lightface is stored. When the user turns on the boldface switch and inputs a character or the like, the position of the inputted character or the like in boldface is stored. When neither of the light face and boldface switches is turned on, an object placed in the region within the hollow input-use interior S is recognized as the tip E₁ of the eraser E, and the size of the eraser tip E₁ (a fixed value from the center) is determined. When the user actually erases the character or the like written on the paper sheet with the eraser tip E1, the inputted information lying in the range within which the eraser tip E₁ is moved is moved to the next page (layer), and is erased from the original page (layer) in terms of data. After the use of the eraser E is completed, a third page (layer) following the aforementioned next page (layer) is prepared (counting up of N), and the user performs an input operation on the third page (layer) in the aforementioned manner. In this manner, each time the eraser E is used, the page feed in terms of data is performed (i.e., the number of layers increases), and erased information is stored for each page (layer). This allows the erased information to be restored (taken) for each page (layer), as required.

Such an input device A is used together with, for example, a personal computer. Specifically, when information such as a document is displayed on a display for the personal computer and a user adds information such as a character, a drawing and a mark to the displayed information or erases the displayed information, the user inputs the information such as a character into the region within the hollow input-use interior 5 of the input device A with the pen P or erases the information with the eraser E. In response to the input and erasure operations, the input device A detects the path of the pen tip P₁ and the eraser tip E₁, and transmits the path as a signal to the personal computer by radio or through a connecting cable, so that the information appears on the display and is erased from the display. The information such as a character inputted by means of the input device A which is superimposed on the information such as a document appears on the display, or the information such as a document from which the information such as a character erased by means of the input device A is eliminated appears on the display.

Software (a program) for converting coordinates in the region within the hollow input-use interior S of the input device A into coordinates on the screen of the display to display or erase a character or the like inputted or erased by means of the input device A is incorporated in the personal computer used herein for the purpose of displaying or erasing the character or the like inputted or erased in the hollow input-use interior S of the input device A in a position on the display corresponding to the input or erasure position.

It should be noted that the information such as a document is, in general, previously stored in an information storage medium such as a hard disk in the personal computer and an external USB memory device, and is outputted from the information storage medium. The information appearing or erased on the display which is the superimposition of the information such as a character inputted or erased by means of the input device A on the information such as a document may be stored in the information storage medium.

Next, the input device according to a second preferred embodiment will be described. According to the second preferred embodiment, a program incorporated in the CPU of the control means C is previously set so as to recognize an object having a size less than a first fixed value (a) as a lightface pen tip P₁, to recognize an object having a size which is not less than the first fixed value (a) and is less than a second fixed value (b) (where a<b) as a boldface pen tip P₁, and to recognize an object having a size not less than the second fixed value (b) as the eraser tip E₁. The lightface switch and the boldface switch which are provided according to the first preferred embodiment are not provided according to the second preferred embodiment. Other parts of the second preferred embodiment are similar to those of the first preferred embodiment described above.

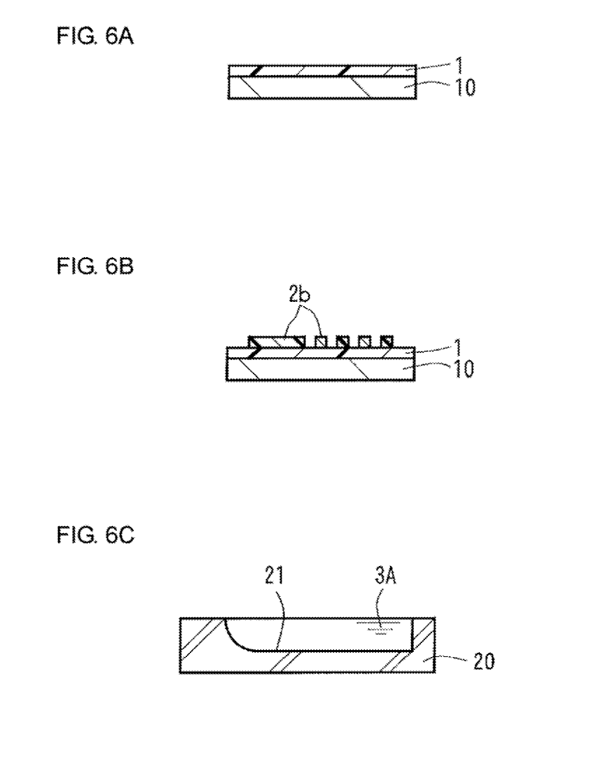

In the second preferred embodiment, the program incorporated in the CPU of the control means C effects control as shown in the flow diagram of FIG. 4. Specifically, when a user places the pen tip P₁ in the region within the hollow input-use interior S, the position of the center of the pen tip P₁ is judged. Subsequently, the size of the pen tip P₁ (a fixed value from the center) is determined. Then, the user inputs a character or the like. When the determined size is less than the first fixed value (a), the position of the inputted character or the like in lightface is stored. When the determined size is not less than the first fixed value (a) and is less than the second fixed value (b), the position of the inputted character or the like in boldface is stored. When the determined size is not less than the second fixed value (b), the object placed in the region within the hollow input-use interior S is recognized as the tip E₁ of the eraser E, and the size of the eraser tip E₁ (a fixed value from the center) is determined. Then, the inputted information lying in the range within which the eraser tip E₁ is moved is erased.

Next, the input device according to a third preferred embodiment will be described. According to the third preferred embodiment, a program incorporated in the CPU of the control means C is previously set so as to be able to restore the information erased in the second preferred embodiment described above. Specifically, the program is previously set so that the information to be erased is erased from the original page (layer) but is moved to the next page (layer) in terms of data, and so that the aforementioned erased information is extracted from the next page (layer), as required. Other parts of the third preferred embodiment are similar to those of the second preferred embodiment described above.

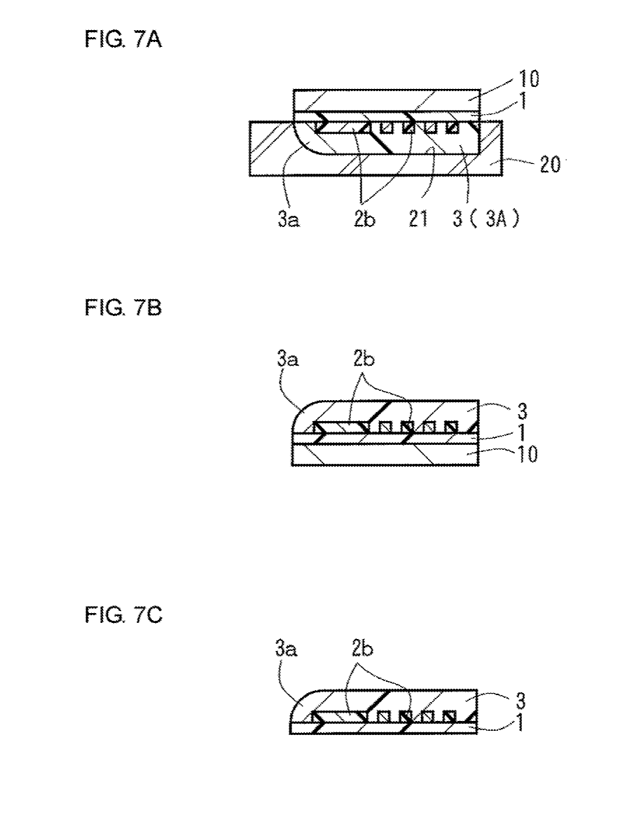

In the third preferred embodiment, the program incorporated in the CPU of the control means C effects control as shown in the flow diagram of FIG. 5. Specifically, when a user places the pen tip P₁ in the region within the hollow input-use interior S, the position of the center of the pen tip P₁ is judged. Subsequently, the size of the pen tip P₁ (a fixed value from the center) is determined. Then, the user inputs a character or the like. When the determined size is less than the first fixed value (a), the position of the inputted character or the like in lightface is stored. When the determined size is not less than the first fixed value (a) and is less than the second fixed value (b), the position of the inputted character or the like in boldface is stored. When the determined size is not less than the second fixed value (b), the object placed in the region within the hollow input-use interior S is recognized as the tip E₁ of the eraser E, and the size of the eraser tip E₁ (a fixed value from the center) is determined. Then, the inputted information lying in the range within which the eraser tip E₁ is moved is moved to the next page (layer), and is erased from the original page (layer) in terms of data. After the use of the eraser E is completed, a third page (layer) following the aforementioned next page (layer) is prepared (counting up of N), and the user performs an input operation on the third page (layer) in the aforementioned manner. In this manner, each time the eraser E is used, the page feed in terms of data is performed (i.e., the number of layers increases), and erased information is stored for each page (layer). This allows the erased information to be restored (taken) for each page (layer), as required.

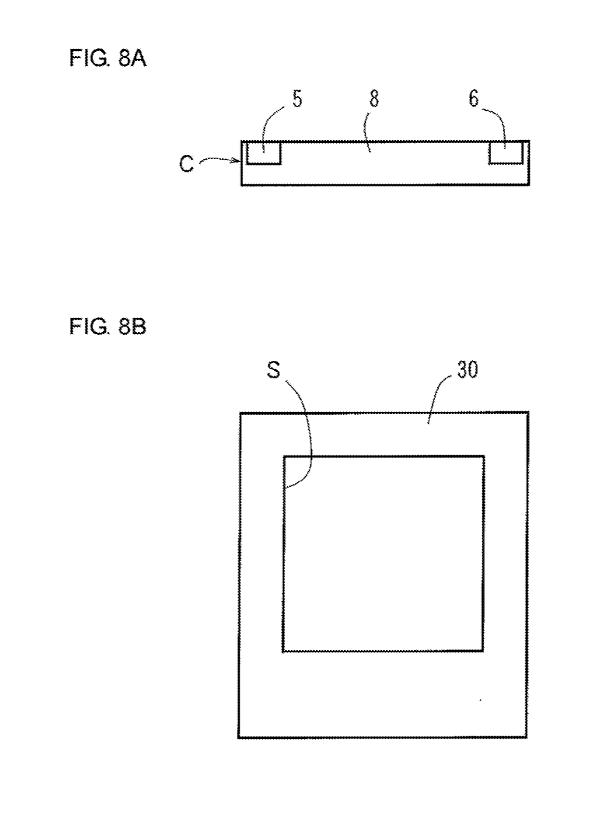

Next, an exemplary method of producing the input device A will be described. In the above-described preferred embodiments, the rectangular frame-shaped optical waveguide W is produced by individually producing the strip-shaped optical waveguide sections corresponding to the respective sides of the rectangular frame shape of the optical waveguide W and then connecting the strip-shaped optical waveguide sections together into the shape of the rectangular frame. It should be noted that FIGS. 6A to 6C, and 7A to 7C referenced for description on the method of producing the optical waveguide W show portions corresponding to a cross section taken along the line X1-X1 of FIG. 2A.

First, a substrate 10 for the formation of each of the strip-shaped optical waveguide sections (with reference to FIG. 6A) is prepared. Examples of a material for the formation of this substrate 10 include metal, resin, glass, quartz, and silicon.

Then, as shown in FIG. 6A, the strip-shaped under cladding layer 1 is formed on a surface of the substrate 10. This under cladding layer 1 may be formed by a photolithographic method using a photosensitive resin as a material for the formation thereof. The under cladding layer 1 has a thickness in the range of 5 to 50 μm, for example.

Next, as shown in FIG. 6B, the light-emitting cores 2a and the light-receiving cores 2b which have the aforementioned pattern are formed on a surface of the under cladding layer 1 by a photolithographic method. An example of a material for the formation of the cores 2a and 2b used herein includes a photosensitive resin having a refractive index higher than that of the materials for the formation of the under cladding layer 1 and the over cladding layer 3 to be described be low (with reference to FIG. 7B).

As shown in FIG. 6C, a light-transmissive mold 20 for the formation of the over cladding layer 3 is prepared. The mold 20 includes a cavity 21 having a mold surface complementary in shape to the surface of the over cladding layer 3 (with reference to FIG. 7B). The mold 20 is placed on a molding stage (not shown), with the cavity 21 positioned to face upward. Then, the cavity 21 is filled with a photosensitive resin 3A serving as the material for the formation of the over cladding layer 3.

Then, as shown in FIG. 7A, the cores 2a and 2b patterned on the surface of the under cladding layer 1 are positioned relative to the cavity 21 of the mold 20. In that state, the under cladding layer 1 is pressed against the mold 20, so that the cores 2a and 2b are immersed in the photosensitive resin 3A serving as the material for the formation of the over cladding layer 3. In this state, the photosensitive resin 3A is exposed to irradiation light such as ultraviolet light by directing the irradiation light through the mold 20 onto the photosensitive resin 3A. This exposure cures the photosensitive resin 3A to form the over cladding layer 3 in which part of the over cladding layer 3 corresponding to the tips of the cores 2a and 2b is formed as the lens portion 3a.

Next, as shown in FIG. 7B (shown in an orientation vertically inverted from that shown in FIG. 7A), the over cladding layer 3 together with the substrate 10, the under cladding layer 1, and the cores 2a and 2b is removed from the mold 20 (with reference to FIG. 7A).

Then, as shown in FIG. 7C, the substrate 10 (with reference to FIG. 7B) is stripped from the under cladding layer 1. This provides each of the strip-shaped optical waveguide sections including the under cladding layer 1, the cores 2a and 2b, and the over cladding layer 3.

Next, as shown in plan view in FIG. 8A, the circuit board 8 is prepared, and the control means C is produced by mounting on the circuit board 8 the following parts: the light-emitting element 5; the light-receiving element 6; the CPU (not shown) for controlling the input device A (with reference to FIG. 1); the output module (not shown) for outputting information inputted into the region within the hollow input-use interior S of the optical waveguide W (with reference to FIG. 1); the storage means (not shown); the battery (not shown); and the like. For the production of the control means C according to the first preferred embodiment described above, the light face switch and the boldface switch are also mounted on the circuit board 8.

The rectangular frame-shaped retainer plate 30 having the hollow input-use interior S is prepared, as shown in plan view in FIG. 8B. Examples of a material for the formation of the retainer plate 30 include metal, resin, glass, quartz and silicon. In particular, stainless steel is preferable in having a good ability to hold the planarity thereof. The retainer plate 30 has a thickness of approximately 0.5 mm, for example.

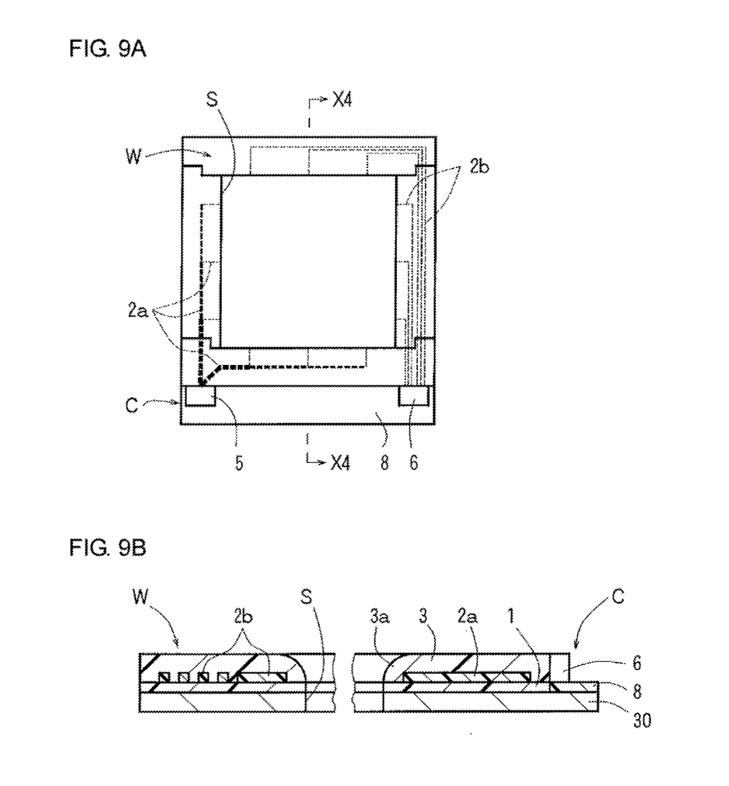

As shown in plan view in FIG. 9A and shown in sectional view (a sectional view taken along the line X4-X4 of FIG. 9A) in FIG. 9B, the strip-shaped optical waveguide sections are affixed to the surface of the rectangular frame-shaped retainer plate 30 to produce the rectangular frame-shaped optical waveguide W. At this time, the light-emitting element 5 is connected to the light-emitting cores 2a, and the light-receiving element 6 is connected to the light-receiving cores 2b.

Thereafter, as shown in sectional view in FIG. 10, the top surface of the over cladding layer 3 except the lens portion 3a, and the control means C are covered with the protective plate 40. Examples of a material for the formation of the protective plate 40 include resin, metal, glass, quartz, and silicon. The protective plate 40 has a thickness of approximately 0.5 mm when made of metal, and approximately 0.8 mm when made of resin, for example.

In this manner, the input device A is produced. Part of the input device A corresponding to the optical waveguide W, together with the retainer plate 30 and the protective plate 40 on the front and back surfaces thereof, is as thin as approximately 3 mm in total thickness. Part of the input device A corresponding to the control means C, together with the retainer plate 30 and the protective plate 40 on the front and back surfaces thereof, is as thin as approximately 3 mm in total thickness. In the above-described preferred embodiments, the part of the input device A corresponding to the optical waveguide W and the part of the input device A corresponding to the control means C are equal in thickness to each other.

For the purpose of improving the light transmission efficiency within the hollow input-use interior S of the rectangular frame-shaped optical waveguide W of the input device A according to the aforementioned preferred embodiments, the tips of the light-emitting cores 2a and the tips of the light-receiving cores 2b are formed as the lens portions, and the edge portion of the over cladding layer 3 covering the lens portions at the tips of the cores 2a and 2b is formed as the lens portion 3a. However, when the light transmission efficiency within the hollow input-use interior S is sufficient, the aforementioned lens portion(s) may be formed only in either the cores 2a and 2b or the over cladding layer 3, or may be formed in neither the cores 2a and 2b nor the over cladding layer 3. When the aforementioned lens portions are not formed, a separate lens element may be prepared and provided along the peripheral edges within the hollow input-use interior S of the optical waveguide W.

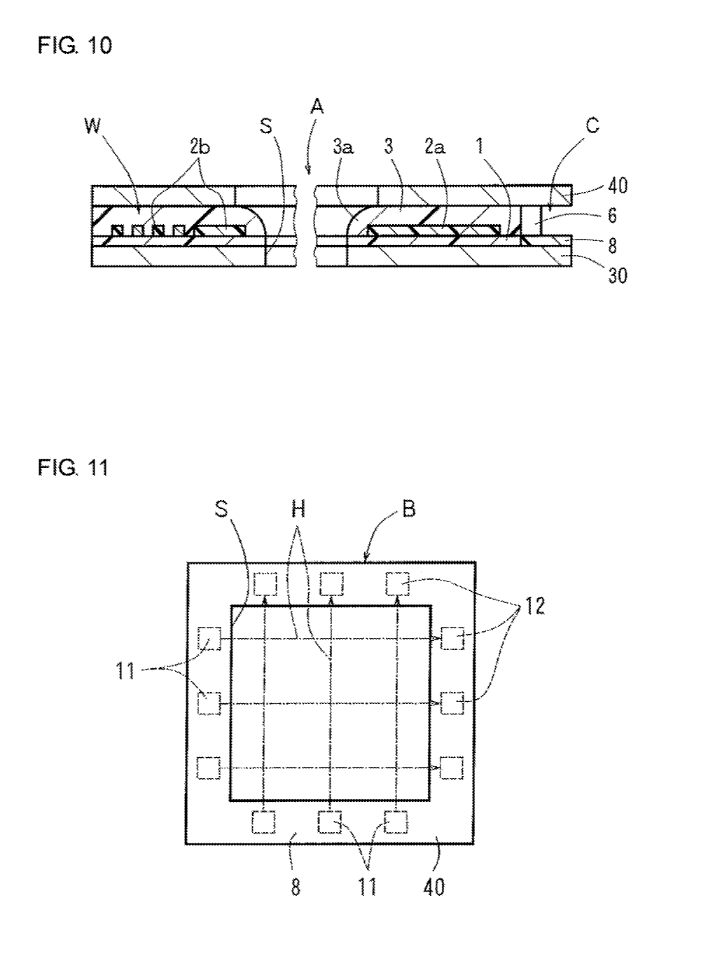

FIG. 11 shows an input device according to a fourth preferred embodiment. The input device B according to the fourth preferred embodiment includes: a rectangular frame-shaped retainer plate having the rectangular hollow input-use interior S; light-emitting diodes (light-emitting means) 11 disposed in juxtaposition on one of the opposed peripheral sections of the retainer plate around the hollow input-use interior S; and photodiodes (light-receiving means) 12 disposed in juxtaposition on the other peripheral section of the retainer plate. Light-emitting sections of the light-emitting diodes 11 are opposed to light-receiving sections of the photodiodes 12. The optical waveguide W (with reference to FIG. 1) is not provided in the input device B. It should be noted that the light-emitting diodes 11 and the photodiodes 12 are mounted on the rectangular frame-shaped circuit board 8 provided on a surface of the retainer plate. As in the first preferred embodiment described above, a CPU for controlling the input device B, a lightface switch, a boldface switch, an output module for outputting information inputted into the region within the hollow input-use interior S, a storage means, a battery, and the like are mounted on the circuit board 8. Further, the protective plate 40 is also provided. In FIG. 11, the number of light-emitting diodes 11 and the number of photodiodes 12 are shown as abbreviated.

Also in the fourth preferred embodiment, the light-emitting diodes 11 cause light beams H to travel in a lattice form in the region within the hollow input-use interior S. When a user moves the pen P and the eraser E in the region within the hollow input-use interior S, some of the light beams H traveling in the lattice form are intercepted by the pen tip P₁ and the eraser tip E₁. The photodiodes 12 sense the interception of light beams to thereby detect the path of the pen tip P₁ and the eraser tip E₁. In other words, the input device B according to the fourth preferred embodiment is used in a manner similar to that in the input device A according to the first preferred embodiment, and is similar in function and effect to the input device A according to the first preferred embodiment.

Also, the light-emitting diodes 11 and the photodiodes 12 may be used in a manner similar to that in the fourth preferred embodiment in place of the optical waveguide W and the light-emitting and light-receiving elements 5 and 6 connected to the optical waveguide W in the second and third preferred embodiments, whereby input devices according to fifth and sixth preferred embodiments are provided. The input devices according to the fifth and sixth preferred embodiments are similar in function and effect to the input devices according to the second and third preferred embodiments.

In the aforementioned preferred embodiments, the size of the eraser tip E₁ is greater than that of the pen tip P₁. However, the size of the eraser tip E₁ may be made less than that of the pen tip P₁, and the program for the CPU may be accordingly changed.

Inputted characters and the like are classified into lightface and boldface in the aforementioned preferred embodiments. However, inputted characters and the like may be displayed in different colors in accordance with the size thereof on the display.

The size of the pen tip P₁ for input use is determined according to the second, third, fifth and sixth preferred embodiments. Instead, the pen P being used may be put in a slanting position, so that the pen P is determined to have a larger size. This allows the input operation in two sizes, i.e. lightface and boldface, with the single pen P.

Further, in the aforementioned preferred embodiments, when a user writes a circle, for example, in a corner of the hollow input-use interior S, next information may be adapted to be inputted to the next page (layer) in terms of data. Also, when a user draws a strike-through line (a double line), for example, over the inputted information, the information may be adapted to be erased in terms of data without the use of the eraser E. In other words, the program for the CPU may be set so that, when an input operation with a particular action is done within the hollow input-use interior S, a function corresponding to the particular action is performed.

If there is a shaving of the eraser E, a foreign substance or the like within the hollow input-use interior S, the input devices A and B sense the shaving of the eraser E or the like. Thus, when an input operation is done with the pen P in that state, two or more objects are sensed. In such a case, an alarm may be issued. This informs a user that the shaving of the eraser E or the like is present within the hollow input-use interior S.

Although inputted characters and the like are classified into lightface and boldface in the aforementioned preferred embodiments, such classification need not be performed. In other words, the inputted characters and the like may be of a single size.

In the aforementioned preferred embodiments, the pen (a writing implement) P is used as the input element. The input element is an implement used for inputting a character and the like within the hollow input-use interior S. A human finger, a rod, and the like may be used as the input element, if there is no need to write on a paper sheet. The eraser E is used as the erasing element in the aforementioned preferred embodiments. The erasing element is an implement used for erasing inputted data. A rod of a large size and the like distinguishable from the pen tip P₁ may be used as the erasing element, if there is no need to erase information written on a paper sheet.

In the aforementioned preferred embodiments, the input devices A and B are used together with a personal computer, and the information inputted to the input devices A and B is displayed on a display for the personal computer. Alternatively, functionality similar to that of the personal computer in the aforementioned preferred embodiments may be imparted to the input devices A and B or to the display, so that information is displayed on the display without using the personal computer.

Next, examples of the present invention will be described. It should be noted that the present invention is not limited to the examples.

### EXAMPLES

### Examples 1 to 3

### Material for Formation of Under Cladding Layer

Component A: 75 parts by weight of an epoxy resin containing an alicyclic skeleton (EHPE 3150 available from Daicel Chemical Industries, Ltd.).

Component B: 25 parts by weight of an epoxy-group-containing acrylic polymer (MARPROOF G-0150M available from NOF Corporation).

Component C: four parts by weight of a photo-acid generator (CPI-200K available from San-Apro Ltd.).

A material for the formation of an under cladding layer was prepared by dissolving these components A to C together with five parts by weight of an ultraviolet absorber (TINUVIN 479 available from Ciba Japan K.K.) in cyclohexanone (a solvent).

### <Material for Formation of Cores>

Component D: 85 parts by weight of an epoxy resin containing a bisphenol A skeleton (157S70 available from Japan Epoxy Resins Co., Ltd.).

Component E: five parts by weight of an epoxy resin containing a bisphenol A skeleton (EPIKOTE 828 available from Japan Epoxy Resins Co., Ltd.).

Component F: 10 parts by weight of an epoxy-group-containing styrenic polymer (MARPROOF G-0250SP available from NOF Corporation).

A material for the formation of cores was prepared by dissolving these components D to F and four parts by weight of the aforementioned component C in ethyl lactate.

### <Material for Formation of Over Cladding Layer>

Component G: 100 parts by weight of an epoxy resin having an alicyclic skeleton (EP4080E available from ADEKA Corporation).

A material for the formation of an over cladding layer was prepared by mixing this component G and two parts by weight of the aforementioned component C together.

### <Production of Optical Waveguide>

The material for the formation of the under cladding layer was applied to a surface of a substrate made of stainless steel (having a thickness of 50 μm). Thereafter, a heating treatment was performed at 160° C. for two minutes to form a photosensitive resin layer. Then, the photosensitive resin layer was exposed to irradiation with ultraviolet light at an integrated dose of 1000 mJ/cm². Thus, the under cladding layer having a thickness of 10 μm (with a refractive index of 1.510 at a wavelength of 830 nm) was formed.

Then, the material for the formation of the cores was applied to a surface of the under cladding layer. Thereafter, a heating treatment was performed at 170° C. for three minutes to form a photosensitive resin layer. Next, the photosensitive resin layer was exposed to irradiation with ultraviolet light at an integrated dose of 3000 mJ/cm² through a photomask (with a gap of 100 μm). Subsequently, a heating treatment was performed at 120° C. for 10 minutes. Thereafter, development was performed using a developing solution (γ-butyrolactone) to dissolve away unexposed portions. Thereafter, a drying process was performed at 120° C. for five minutes. Thus, the cores having a width of 30 μm and a height of 50 μm (with a refractive index of 1.570 at a wavelength of 830 nm) were patterned.

A light-transmissive mold for the formation of the over cladding layer was prepared. This mold includes a cavity having a mold surface complementary in shape to the surface of the over cladding layer. The mold was placed on a molding stage, with the cavity positioned to face upward. Then, the cavity was filled with the material for the formation of the over cladding layer.

Then, the cores patterned on the surface of the under cladding layer were positioned relative to the cavity of the mold. In that state, the under cladding layer was pressed against the mold, so that the cores were immersed in the material for the formation of the over cladding layer. In this state, exposure was performed at an integrated dose of 8000 mJ/cm² by irradiating the material for the formation of the over cladding layer with ultraviolet light through the mold. Thus, the over cladding layer was formed in which a portion thereof corresponding to the tips of the cores was in the form of a convex lens portion. The convex lens portion had a substantially quadrantal curved lens surface (having a radius of curvature of 1.4 mm) as seen in sectional side view.

Next, the over cladding layer together with the substrate, the under cladding layer and the cores was removed from the mold.

Then, the substrate was stripped from the under cladding layer. This provided each strip-shaped optical waveguide section (having a total thickness of 1 mm) including the under cladding layer, the cores, and the over cladding layer.

### <Production of Input Device>

Next, a circuit board was prepared, and a control means was produced by mounting a light-emitting element (SM85-2N001 available from Optowell Co., Ltd.), a light-receiving element (S-10226 available from Hamamatsu Photonics K.K.), a CMOS driving CPU, a crystal oscillator, a wireless module, two coin-type lithium cells (CR1216 having a thickness of 1.6 mm, a diameter of 1.25 mm, and a voltage of 3 V) and the like onto the circuit board. A program for the CPU shown in the flow diagram of FIG. 3 was that for Example 1; a program for the CPU shown in the flow diagram of FIG. 4 was that for Example 2; and a program for the CPU shown in the flow diagram of FIG. 5 was that for Example 3.

A rectangular frame-shaped retainer plate made of stainless steel (having a thickness of 0.5 mm) was prepared. The retainer plate had a hollow input-use interior in the form of a rectangle that was 30 cm in length and 30 cm in width. The strip-shaped optical waveguide sections were affixed to a portion of a surface of the retainer plate which was outside the hollow input-use interior to produce a rectangular frame-shaped optical waveguide, and the control means was fixed thereon. At this time, the light-emitting element was connected to light-emitting ones of the cores, and the light-receiving element was connected to light-receiving ones of the cores. Thereafter, the top surface of the over cladding layer except the lens portion and the fixed portion of the control means were covered with a rectangular frame-shaped protective plate made of stainless steel (having a thickness of 0.5 mm). This provided an input device. Part of the input device corresponding to the optical waveguide, together with the retainer plate and the protective plate on the front and back surfaces thereof, had a total thickness of 2 mm. Part of the input device where the control means was fixed, together with the retainer plate and the protective plate on the front and back surfaces thereof, had a total thickness of 3 mm.

### Examples 4 to 6

### Production of Input Device

A rectangular frame-shaped retainer plate similar to that in Examples 1 to 3 was prepared. Light-emitting diodes (GL4800E0000F available from Sharp Corporation) were disposed in juxtaposition on one of the opposed peripheral sections of the retainer plate around the hollow input-use interior, and photodiodes (PD411PI2E00P available from Sharp Corporation) were disposed in juxtaposition on the other peripheral section of the retainer plate. Also, in a manner similar to that in Examples 1 to 3, a control means was produced by mounting a CMOS driving CPU, a crystal oscillator, a wireless module, two coin-type lithium cells and the like onto a circuit board, and the control means was fixed on the retainer plate. A program for the CPU shown in the flow diagram of FIG. 3 was that for Example 4; a program for the CPU shown in the flow diagram of FIG. 4 was that for Example 5; and a program for the CPU shown in the flow diagram of FIG. 5 was that for Example 6. The light-emitting diodes, the photodiodes and the control means were covered with a rectangular frame-shaped protective plate made of stainless steel (having a thickness of 0.5 mm). This provided an input device. The input device was uniform in thickness, and had a total thickness of 3 mm.

### <Operation Check of Input Device>

A USB memory device with information such as a document stored therein, and a personal computer were prepared. The information stored in the USB memory device was displayed on a display for the personal computer by the use of the personal computer. Software (a program) for converting coordinates in the region within the rectangular frame-shaped hollow input-use interior of the input device into coordinates on the screen of the display to display a character or the like inputted by means of the input device is incorporated in the personal computer. The personal computer included a receiving means so as to be able to receive radio waves (information) from the wireless module of the input device. The personal computer and the input device were connected for transmission of information therebetween by radio.

The input device in each of Examples 1 to 6 described above was placed on a paper sheet, with the stainless steel retainer plate downside. Next, a character was written with a pen on the paper sheet revealed in the region within the hollow input-use interior. As a result, the character was displayed while being superimposed on the information such as a document appearing on the display. Next, the character written on the paper sheet was erased with an eraser. As a result, the character was erased also on the display.

The input device is applicable to the addition of new information such as characters, drawings, marks and the like to documents and the like appearing on a display, and to the erasure of the information.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. An input device comprising:
a frame-shaped plate having a space surrounded by a frame and serving as a hollow input-use interior, the frame-shaped plate including a pair of sections opposed to each other;
a light-emitting means provided on one of the opposed sections of the frame-shaped plate;
a light-receiving means provided on the other of the opposed sections of the frame-shaped plate and for receiving light emitted from the light-emitting means, the input device being configured such that the path of movement of a tip input part of an input element within the hollow input-use interior serves as input information;
a size recognizing means for recognizing a tip erasing part of an erasing element different in size from the tip input part of the input element, when the tip erasing part is moved within the hollow input-use interior; and
an erasure information recognizing means for recognizing inputted information over which the tip erasing part is moved as erasure information.

2. The input device according to claim 1, wherein the tip erasing part of the erasing element is greater in size than the tip input part of the input element.

3. The input device according to claim 1,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

4. The input device according to claim 1,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.

5. The input device according to claim 2,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

6. The input device according to claim 2,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.
